(19) United States
(12) Patent Application Publication
(10) Pub. No.: US 2016/0101424 A1
(43) Pub. Date: Apr. 14, 2016

(54) ROLLER MILL

(71) Applicant: THYSSENKRUPP INDUSTRIAL SOLUTIONS AG, Essen (DE)

(72) Inventors: Daniel Frerich, Lippstadt (DE); Ludwig Konning, Ahlen (DE); Nils Horster, Ennigerloh (DE); Alexander Peters, Beckum (DE)

(73) Assignee: THYSSENKRUPP INDUSTRIAL SOLUTIONS AG, Essen (DE)

(21) Appl. No.: 14/786,933

(22) PCT Filed: Apr. 22, 2014
(86) PCT No.: PCT/EP2014/058099

§ 371 Date: Oct. 23, 2015

(30) Foreign Application Priority Data
Apr. 23, 2013 (DE) 10 2013 104 097.7

(51) Int. Cl. B02C 4/28; B02C 4/02

(52) U.S. Cl. CPC B02C 4/28; B02C 4/02

(57) ABSTRACT

Disclosed is a roller mill having two roller units disposed in a machine frame with each having one grinding roller rotatably mounted in two bearing jewels. The two grinding rollers are disposed mutually opposite each other and counter-rotatingly driven by a drive mechanism. A force-application system configured to generate a grinding force is coupled between the machine frame and at least one roller unit, wherein the grinding force is transmitted to the grinding rollers. The machine frame is composed of a plurality of frame parts, wherein for transmitting the grinding force a releasable and positive locking connection to two mutually compressed connection faces is provided between at least two interconnected frame parts, and/or between at least one frame part and one of the bearing jewels, wherein at least one of the two mutually compressed connection faces has a coating which generates a micro positive lock.

The invention relates to a roller mill having two roller units which are disposed in a machine frame and which have in each case one grinding roller which is rotatably mounted in two bearing jewels, wherein the two grinding rollers are disposed so as to be mutually opposite and for mutually counter-rotating driving of the grinding rollers are in each case linked to a drive.

A force-application system for generating a grinding force is provided between the machine frame and at least one roller unit wherein the grinding force is transmitted via the machine frame composed of a plurality of frame parts, and the bearing jewels to the grinding rollers. Here, for transmitting the grinding force a releasable and positive locking connection to two mutually compressed connection faces is provided between at least two interconnected frame parts, and/or between a frame part and one of the bearing jewels.

Since the grinding rollers are subject to wear during operation, scheduled replacement of the rollers is required wherein the roller units are removed from the machine frame once the connection between the grinding roller and the drive has been released. This roller replacement in the case of material-bed type roller mills is required about 3 times per year and is in each case associated with a significant investment in time, such that possibilities for accelerating roller replacement have been sought, such as disclosed in DE 10 2010 048 214 A1, for example.

Typically, positive locking connections in the form of round or planar fitting-key connections or else bolt connections are used in the connection of the frame parts of the machine frame. During disassembly the connection between the pressure beams and an upper frame part (which is also referred to as the top boom) and a lower frame part is released, such that the upper frame part may be raised and the pressure beams and the roller unit(s) be removed. This disassembly operation remains complex and time consuming.

The invention is thus based on the object of enabling more rapid disassembly and assembly of a roller unit.

According to the invention, this object is achieved by a roller mill having two roller units which are disposed in a machine frame and which have in each case one grinding roller which is rotatably mounted in two bearing jewels, wherein
the two grinding rollers are disposed so as to be mutually opposite and for mutually counter-rotating driving of the grinding rollers are in each case linked to a drive,
a force-application system for generating a grinding force is provided between the machine frame and at least one roller unit wherein the grinding force is transmitted via the machine frame and the bearing jewels to the grinding rollers, and
the machine frame is composed of a plurality of frame parts, wherein for transmitting the grinding force a releasable and positive locking connection to two mutually compressed connection faces is provided between at least two interconnected frame parts, and/or between at least one frame part and one of the bearing jewels, wherein at least one of the two mutually compressed connection faces has a coating which generates a micro positive lock.

The coating which generates a micro positive lock has the advantage that the connection faces need to be raised by only a few millimeters in order to enable removal of the roller unit. On account of the coating which generates a micro positive lock the force which can be transmitted between the two connection faces is significantly increased, such that high grinding forces of 16 000 kN or more, for example, such as arise, for example, in the case of material-bed type roller mills or roller presses in the cement and minerals industry, respectively, may also be transmitted.

Further design embodiments of the invention are the subject matter of the dependent claims.

According to one further design embodiment of the invention, tensioning means, for example in the form of a multiplicity of screw connections, are provided for mutually compressing the two connection faces. The coating, which generates a micro positive lock, of the interconnected frame parts, and/or of the frame part and the bearing jewel, is preferably configured such that the connection is completely cancelled by raising the two connection faces apart by at maximum 4 mm.

The connection faces are preferably configured so as to be planar, and the coating which generates a micro positive lock may be formed in particular by a hard-material particle coating, wherein the hard-material particles preferably have a hardness according to Mohs of 6 to 10.

According to one preferred design embodiment of the invention, the roller mill is configured such that one roller unit is mounted as a floating roller and the other roller unit is mounted as a fixed roller in the machine frame, wherein the force-application system is disposed between the machine frame and the roller unit which functions as a floating roller.

The machine frame is preferably formed by at least one lower frame part, at least one upper frame part, and a plurality of pressure beams which connect the upper and lower frame part. The bearing jewels here on the upper and lower frame part may be guided in a sliding and displaceable manner. The connection faces are either configured on parts of the machine frame, or the coating which generates a micro positive lock is applied onto an intermediate element which is fixedly connected to the parts of the machine frame which are to be connected.

According to a first preferred design embodiment of the roller mill, four pressure beams are provided, wherein two pressure beams serve as counter-bearings of the one roller unit and the two other pressure beams serve as counter-bearings of the other roller unit, and the upper and lower frame parts are connected to the four pressure beams by in each case one releasable and positive locking connection to two mutually compressed connection faces, wherein at least two of the mutually compressed connection faces have the coating which generates a micro positive lock.

According to a second design embodiment of the invention, only two pressure beams which are connected to the upper and the lower frame parts and which serve as counter-bearings for the roller unit which functions as a floating roller are provided. The roller unit which functions as a fixed roller, by way of the bearing jewels thereof, then is connected to the upper and lower frame parts via the releasable and positive locking connection to two mutually compressed connection faces, wherein again at least one of the two mutually compressed connection faces has the coating which generates a micro positive lock.

The invention will be explained in more detail hereunder by means of the following description of two exemplary embodiments and by the drawing.

In the drawing:

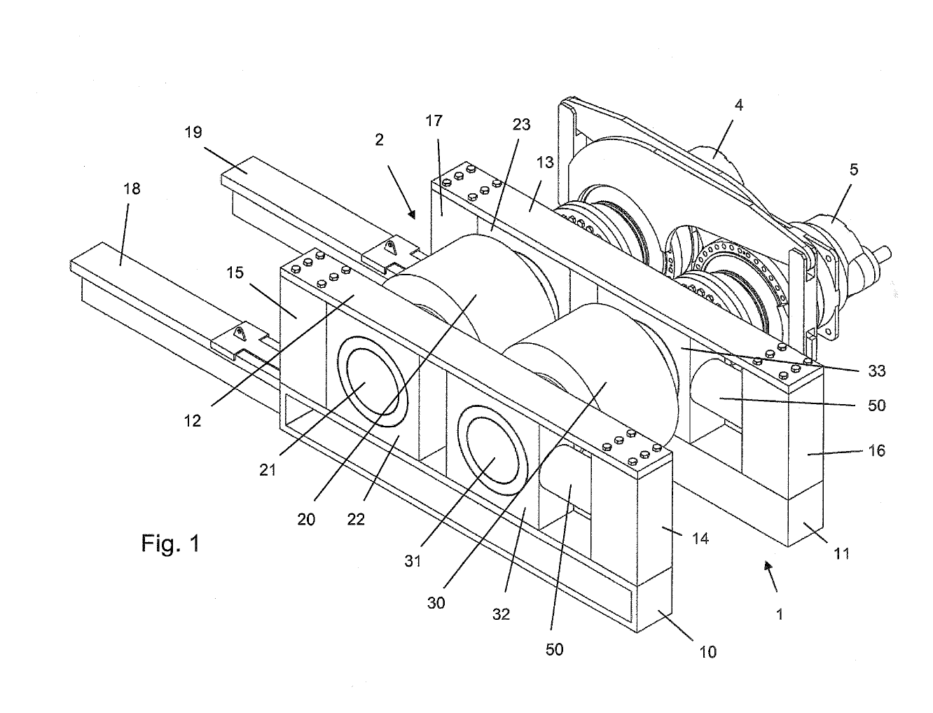

FIG. 1 shows a three-dimensional illustration of a roller mill according to a first exemplary embodiment;

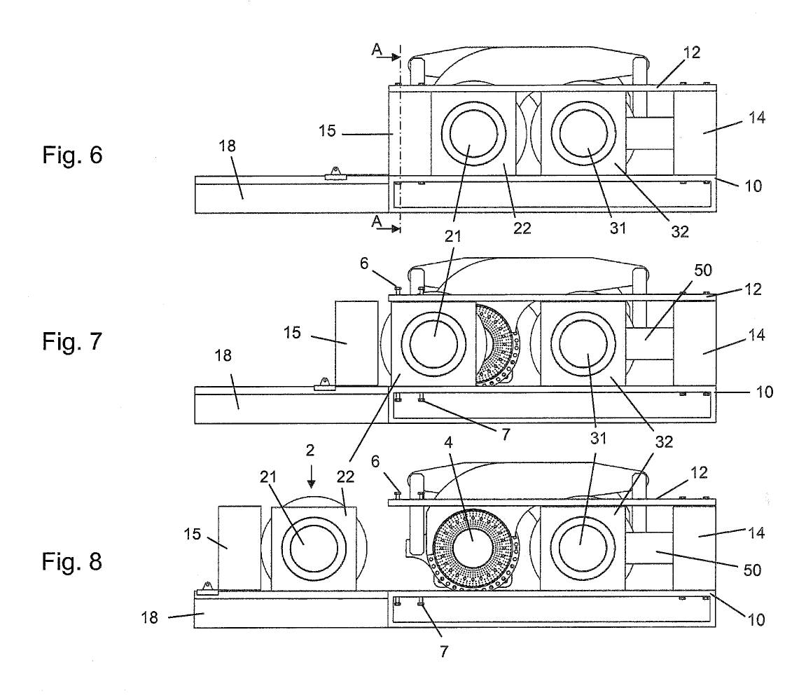

FIG. 2 shows a sectional illustration along the line A-A of FIG. 6, illustrating a side view of FIG. 1;

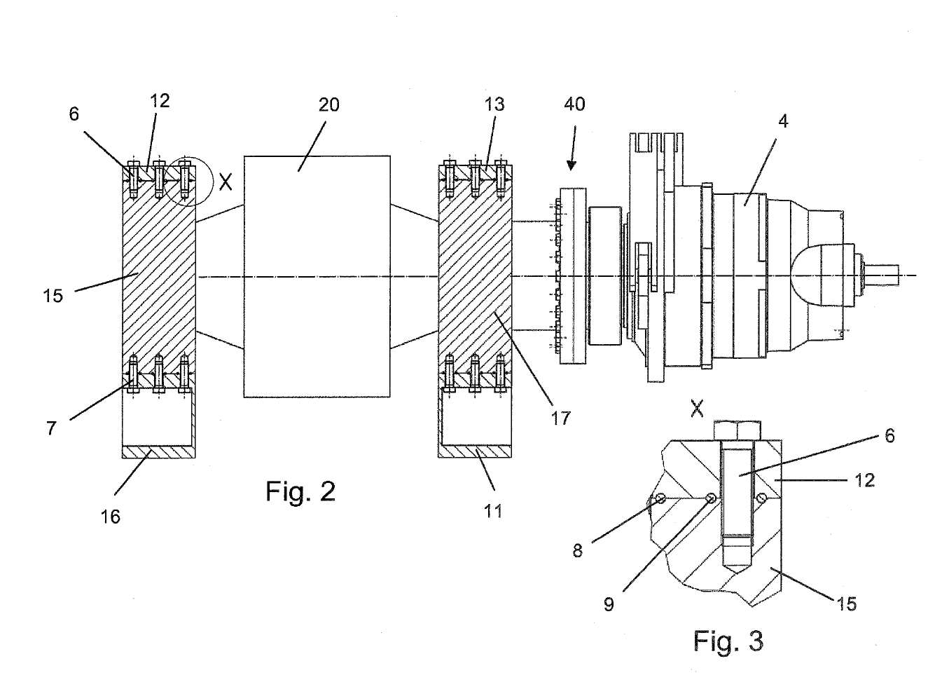

FIG. 3 shows an enlarged view of detail X of FIG. 2;

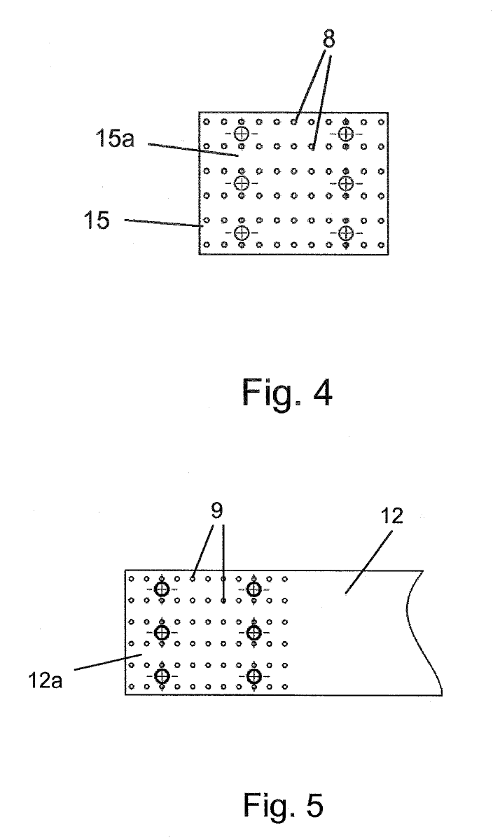

FIG. 4 shows a plan view of the first connection face;

FIG. 5 shows a plan view of the second connection face;

FIG. 6 shows a side view of FIG. 1 in the operational position of the roller mill;

FIG. 7 shows a side view of the roller mill having a disassembled pressure beam;

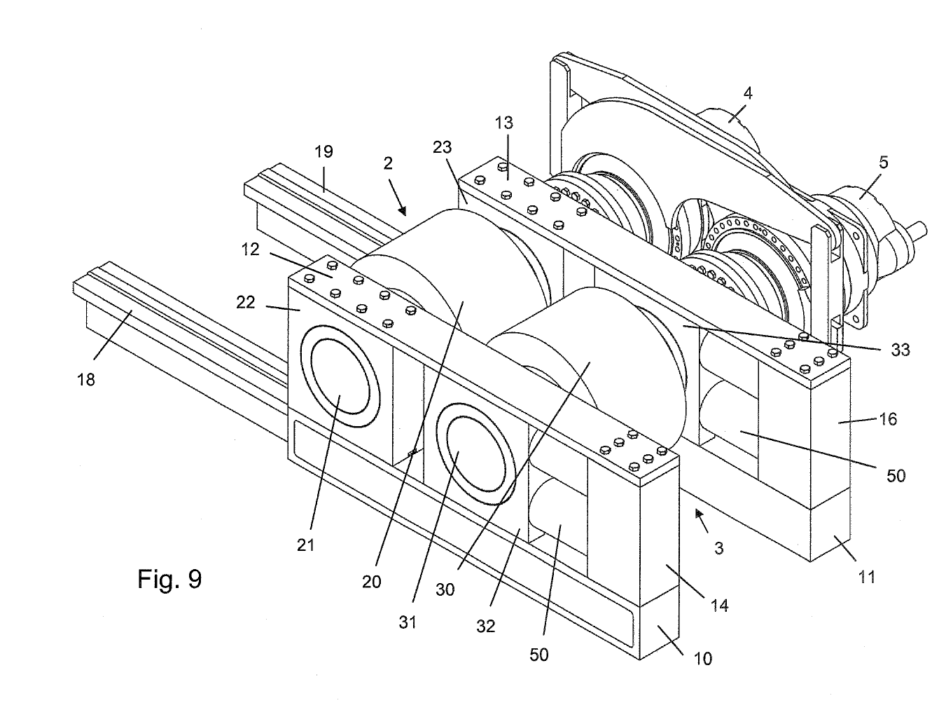

FIG. 8 shows a side view of the roller mill having a disassembled roller unit; and

FIG. 9 shows a three-dimensional illustration of a roller mill according to a second exemplary embodiment.

The roller mill illustrated in FIG. 1 is a roller press or a material-bed type roller mill, for example, having two roller units 2, 3 which are disposed in a machine frame 1 and which have in each case one grinding roller 20 or 30 respectively, wherein the grinding rollers are disposed so as to be mutually opposite and for mutually counter-rotating driving of the grinding rollers are in each case linked to a drive 4, 5. The machine frame is composed of two lower frame parts 10, 11, two upper frame parts 12, 13, and four pressure beams 14 to 17. The grinding rollers 20, 30 are mounted by way of shaft stubs 21 or 31, respectively, in bearing jewels 22, 23, or 32, 33, respectively, wherein the bearing jewels on the upper and lower frame parts 10, 11, 12, 13 are guided in a sliding and displaceable manner.

In the illustrated exemplary embodiment the roller unit 2 is mounted as a fixed roller in the machine frame 1 and is supported by way of the bearing jewels 22, 23 thereof on the pressure beams 15, 17. By contrast, the roller unit 3 is configured as a floating roller. A force-application system 50 for generating a grinding force is provided between the machine frame 1 and the roller unit 3, wherein the grinding force is transmitted via the machine frame 1 and the bearing jewels 22, 23 and 32, 33 to the grinding rollers 20, 30, wherein a grinding gap is maintained between the two grinding rollers. In particular, pressures of 50 MPa or more may be generated here in the grinding gap.

The positive locking connection of the lower and upper frame parts to the pressure beams of the machine frame 1 will be explained in more detail hereunder by means of FIGS. 2 to 5. The pressure beams 14 to 17, by way of screw connections 6, 7, are in each case interconnected to one of the lower frame parts 10, 11, and to one of the upper frame parts 12, 13. It is evident from FIGS. 3 to 5 that a first connection face 15a, which is provided on the pressure beam 15, here is pressed against a second connection face 12a, which is provided on the upper frame part 12. In order for the transmissible force between the pressure beam 15 and the upper frame part 12 to be increased, one, but preferably both, of these connection faces 15a, 12a is provided with a coating 8, 9 which generates a micro positive lock and which is formed, for example, by a hard-material particle coating having a hardness according to Mohs of 4 to 6. Preferably all connection points between the four pressure beams and the upper and lower frame parts are configured in this way.

Disassembly of a roller unit is evident by means of FIGS. 6 to 8. FIG. 6 here shows the roller mill in the operating position thereof, according to FIG. 1. In a first step, the screw connections 6, 7 between the two pressure beams 15, 17 and the assigned lower and upper frame parts are released. Furthermore, the link between the roller unit to be replaced and the drive unit thereof has to be released. This linkage point in FIG. 2 is provided with the reference sign 40. In order for removal of the pressure beams 15, 17 and of the roller unit 2 to be facilitated, guide rails 18, 19 are provided as extensions to the lower frame parts 10, 11.

The two pressure beams 15, 17 may be pulled out by way of the guide rails 18, 19, once the screw connections 6, 7 have been released. It may optionally be expedient for the two upper frame parts 12, 13 to be raised by a chain lift by a few millimeters, or at least held in place, for this purpose. Following on from there, the roller unit 2 is then also completely pulled out. If necessary, the other roller unit 3 is also pulled out, once the connection thereof to the drive 5 has been released. Installation is performed in the reverse sequence.

In FIG. 9 a roller mill according to a second exemplary embodiment is illustrated, differing from the first exemplary embodiment only in that the pressure beams 15, 17 have been omitted and the bearing jewels 22, 23 are directly screwed to the lower and upper frame parts 10, 12, or 11, 13, respectively.

The interconnected regions of the first and second connection faces are preferably covered by at least 50%, most preferably by at least 90%, by the coating which generates a micro positive lock. The individual particles of the coating preferably have a longest average extent of <2 mm. The coating may be selectively applied by adhesive bonding, sintering, varnishing, chemical methods, galvanic methods, suspension or flame-spraying methods. It is also conceivable for the coating which generates a micro positive lock not to be directly applied onto the pressure beams or the lower or upper frame parts, respectively, but rather onto intermediate elements which are in each case fixedly connected to the pressure beams or frame parts.

The great advantage of the coating which generates a micro positive lock lies above all in that already slight raising of the two connection faces by a few millimeters is entirely sufficient for the pressure beams or the roller units, respectively, to be pulled out. This coating nevertheless ensures adequate transmission of the grinding forces via the machine frame. Furthermore, on account of the omission of the previously commonplace face joints, the investment in production is significantly lower and a more compact constructive configuration results therefrom. Assembly of the machine frame is also facilitated on account of the reduced alignment effort, since there is in particular no requirement for seating wedges to be made at the erection site.

1.-11. (canceled)

12. A roller mill, comprising:
a machine frame having a plurality of frame parts interconnected to each other at mated faces thereof;
a first and a second roller unit disposed in said machine frame;
a first pair of bearing jewels disposed in said first roller unit;
a first grinding roller rotatably mounted in said first pair of bearing jewels;
a second pair of bearing jewels disposed in said second roller unit;
a second grinding roller rotatably mounted in said second pair of bearing jewels and disposed mutually opposite said first grinding roller;
a drive unit operatively coupled to each of said first and second grinding rollers and configured to counter-rotatingly drive said grinding rollers; and
a force application system coupled between said machine frame and at least one of said first and second roller units and configured to generate a grinding force to be transmitted via said machine frame and said bearing jewels to said grinding rollers;
two mutually compressed connection faces defined at an interconnection between mated faces of at least one of,
(a) at least two interconnected frame parts, or
(b) at least one frame part and one of said bearing jewels of said first and second pair of bearing jewels; and
a coating disposed on at least one of said two mutually compressed connection faces that is configured to generate a releasable micro positive lock there between for transmitting grinding force.

13. The roller mill of claim 12, further comprising tensioning means configured to mutually compress said two mutually compressed connection faces.

14. The roller mill of claim 13, wherein said tensioning means are a plurality of screw connections that couple said two mutually compressed connection faces together.

15. The roller mill of claim 12, wherein said coating is configured such that said releasable micro positive lock of said interconnected frame parts may be completely released by separating said two mutually compressed connection faces from each other by a maximum distance of 4 mm.

16. The roller mill of claim 12, said two mutually compressed connection faces are planar.

17. The roller mill of claim 12, wherein said coating is a hard-material particle coating.

18. The roller mill of claim 12, said machine frame includes at least one lower frame part, at least one upper frame part, and a plurality of pressure beams coupled there between that connect said upper frame part to said lower frame part.

19. The roller mill of claim 18, wherein each of said bearing jewels are disposed between said upper and lower frame parts and are guided in a sliding and displaceable manner along said upper and lower frame parts.

20. The roller mill of claim 18, further comprising four separate pressure beams, wherein a first and second pressure beams are configured as counter-bearings of said first roller unit, and wherein second and third pressure beams are configured as counter-bearings of said second roller unit, and wherein said upper and lower framed are each connected to said four pressure beams by, in each case, one releasable and positive locking connection to two mutually compressed connection faces, wherein at least two of the mutually compressed connection faces have the coating which generates a micro positive lock.

21. The roller mill of claim 18, further comprising two pressure beams that are connected to said at least one upper and lower frame parts and which serve as counter-bearings for said first roller unit that functions as a floating roller, and said second roller unit that functions as a fixed roller together with the bearing jewels associated therewith, is connected to the upper and the lower frame part via the releasable and positive locking connection to two mutually compressed connection faces, wherein at least one of the two mutually compressed connection faces has the coating which generates a micro positive lock.

22. The roller mill of claim 12, wherein at least one of the connection faces having the coating which generates a micro positive lock is applied onto an intermediate element.
